(19) United States
(12) Patent Application Publication
(10) Pub. No.: US 2014/0288986 A1
(43) Pub. Date: Sep. 25, 2014

(54) Computer-Implemented Method for Auditing Media Content

(71) Applicant: Yung-Nan Hsu, Taichung City (TW)

(72) Inventor: Yung-Nan Hsu, Taichung City (TW)

(21) Appl. No.: 14/299,659

(22) Filed: Jun. 9, 2014

Related U.S. Application Data
(62) Division of application No. 13/584,420, filed on Aug. 13, 2012.

(30) Foreign Application Priority Data
Aug. 16, 2011 (TW) 100129225

(51) Int. Cl. G06Q 10/06

(52) U.S. Cl. CPC G06Q 10/063114
USPC 705/7.15

(57) ABSTRACT

A computer-implemented method for auditing media content is implemented using a host computer. In this method, the host computer is configured to define a task according to a piece of media content, to transmit the piece of media content to a user computer, to receive a message corresponding to completion of the task associated with the piece of media content and transmitted from the user computer after the user computer has completed playback of the piece of media content, and to grant a reward to an account associated with the user computer based on the message.

### CROSS-REFERENCE TO RELATED APPLICATION

This application is a divisional of Ser. No. 13/584,420, filed Aug. 8, 2012 which claims priority of Taiwanese Application No. 100129225, filed on Aug. 16, 2011.

### BACKGROUND OF THE INVENTION

1. Field of the Invention

The present invention relates to a computer-implemented method for auditing media content.

2. Description of the Related Art

Multimedia content has become very common and widely used in industries, businesses, families and everyday life, and has many forms, such as advertisement and real-time surveillance video.

Most advertisement videos fail to attract user attention, and users rarely finish watching the whole video. Therefore, advertising efforts oftentimes fail to achieve the advertisers' expectation.

Real-time surveillance videos are usually long and boring, especially when they are eventless. Since security personnel may lack patience in focusing on monitor screens for a long time, countless incidents are not reported as they happen but only reviewed afterwards. Moreover, opportunities to call for immediate assistance from the police or hospitals at the time of incidents are missed.

### SUMMARY OF THE INVENTION

The object of the present invention is to provide a computer-implemented method for auditing media content.

According to the present invention, a computer-implemented method for auditing media content, is to be implemented using a host computer and comprises the steps of:

(A) configuring the host computer to define a task according to a piece of media content;

(B) configuring the host computer to transmit the piece of media content to a user computer;

(C) configuring the host computer to receive a message corresponding to completion of the task associated with the piece of media content and transmitted from the user computer after the user computer has completed playback of the piece of media content; and

(D) configuring the host computer to grant a reward to an account associated with the user computer based on the message received in step (C).

### BRIEF DESCRIPTION OF THE DRAWINGS

Other features and advantages of the present invention will become apparent in the following detailed description of the preferred embodiment with reference to the accompanying drawings, of which:

FIG. 1 is a schematic illustration of a system to implement the preferred embodiment of the computer-implemented method for auditing media content according to this invention;

FIG. 2 is a schematic illustration of relationships among users of the preferred embodiment; and

FIG. 3 is a flow chart of the preferred embodiment.

### DETAILED DESCRIPTION OF THE PREFERRED EMBODIMENT

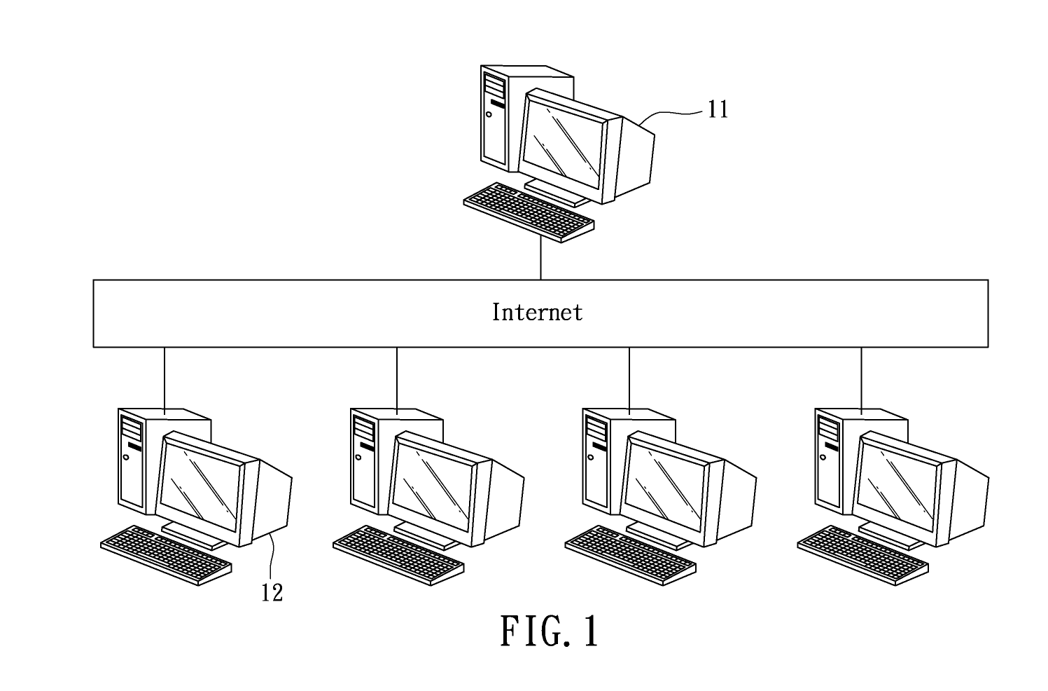

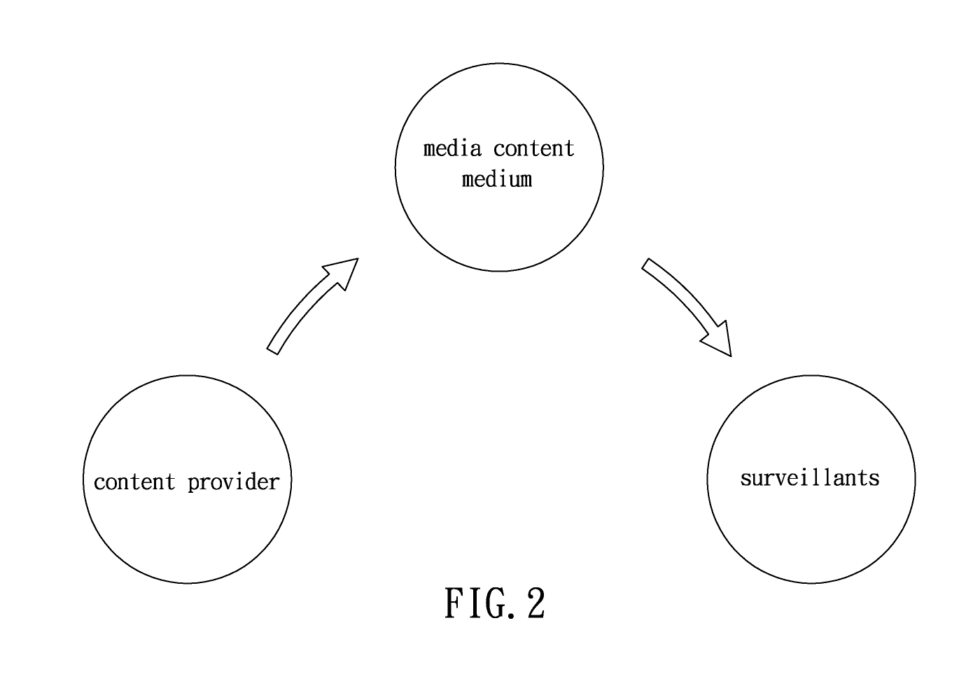

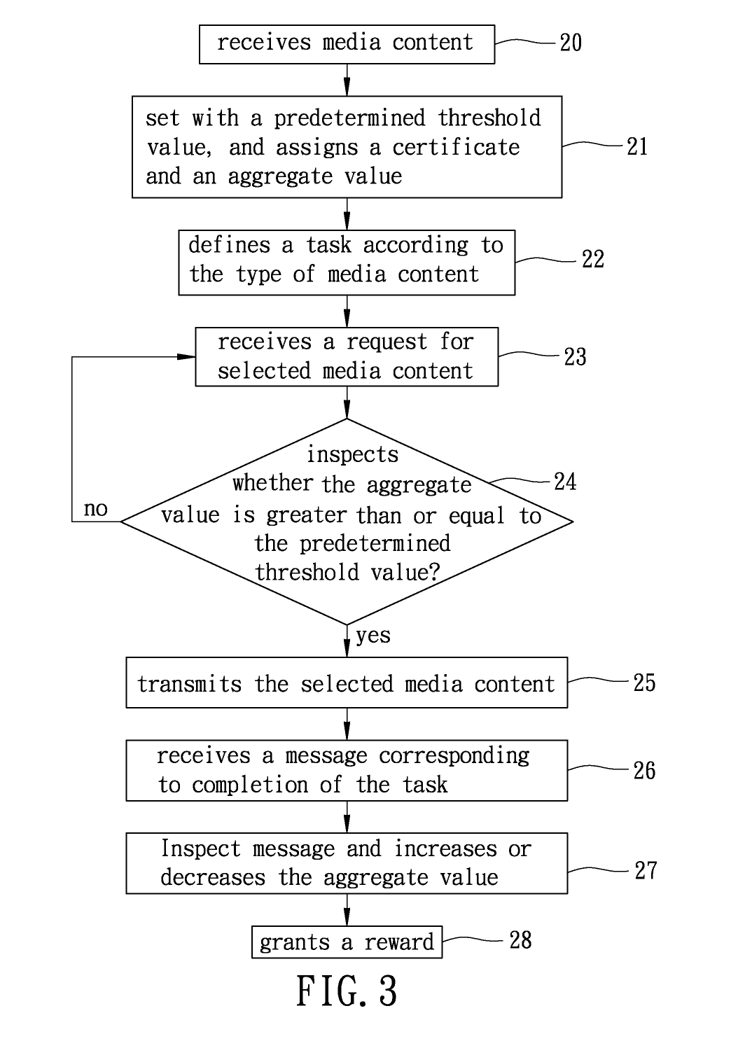

Referring to FIGS. 1, 2 and 3, the computer-implemented method for auditing media content of this invention is to be implemented using a system that includes at least a host computer 11 and a plurality of user computers 12. In a preferred embodiment, the host computer 11 is a media content medium associated with a medium administrator, and the user computers 12 belong to their respective surveillant and are connected to the host computer 11 via the Internet. The computer-implemented method for auditing media content includes the following steps:

Step 20: The host computer 11 receives media content from a client computer associated with a content provider.

The content provider must pay a fee to the administrator of the host computer 11 for availing of a media auditing service.

Step 21: The host computer 11 is set with a predetermined threshold value, and assigns a certificate and an aggregate value to an account associated with the user computer 12 and established by conducting a certification process with the user computer 12.

For instance, if the predetermined threshold value is set to be 10 points, the aggregate value starts at 10 points. In the preferred embodiment, the certificate is a set of account and password associated the user computer 12.

Step 22: The host computer 11 defines a task according to the type of media content, which can be a segment of advertisement, real-time surveillance video or drama video. The task can be playback in full, finding a difference and monitoring for occurrence of an abnormal event. For instance:

When the media content is an advertisement, the task can be playback in full, and the aggregate value in the account associated with the user computer 12 can be increased by 1 point upon the completion of the task.

When the media content is a real-time surveillance video for monitoring a gate, the task can be set to monitor for any opening of the gate and its time of occurrence, and a maximum value of 5 points can be obtained through accomplishing this task.

Step 23: The host computer 11 receives a request from the user computer 12 for selected media content.

Step 24: The host computer 11 inspects whether the aggregate value assigned to the account associated with the user computer 12 is greater than or equal to the predetermined threshold value (i.e., if the aggregate value 10 points). The flow goes to step 25 if affirmative, and back to step 23 if otherwise.

Step 25: According to the request from the user computer 12, the host computer 11 transmits the selected media content to the user computer 12. Step 26: The host computer 11 receives a notification from the user computer 12 after the user computer 12 has completed the playback of the media content, the host computer 11 then transmits a questionnaire associated with the media content in response to receipt of the notification from the user computer 12, and the host computer 11 receives a message, which is a response from the user computer 12 to the questionnaire transmitted by the host computer 11 and which corresponds to completion of the task associated with the selected media content.

Step 27: According to the message transmitted back from the user computer 12, the host computer 11 increases or decreases the aggregate value of the account associated with the user computer 12 based on the degree of accomplishment of the task. For instance:

Referring to an example for an advertisement video, the host computer 11 can check the response to the questionnaire to see if the user computer 12 has indeed completed the playback and watching of the video, and accordingly adds or subtracts 1 point from the aggregate value of the user computer 12 (10+1=11 or 10−1=9 points).

Referring to an example for a real-time surveillance video, the host computer 11, when notified by the user computer 12, can be used to confirm if a main door is opened, and adds 5 points to the aggregate value of the account associated with the user computer 12 (10+5=15) if the main door is indeed opened. On the other hand, if the main door has been opened and the user computer 12 failed to report such event, the host computer 11 deducts 5 points from the aggregate value of the account associated with the user computer 12 (10−5=5 points).

Step 28: The host computer 11 grants a reward to the account associated with the user computer 12 based on the message received in step 26. The reward in this preferred embodiment may be a monetary reward or a point reward.

According to the above, the computer-implemented method for auditing media content possesses the benefits as follows:
1. The invention utilizes the host computer 11 as a media content medium that provides a trading medium for the user computer 12 and the content provider, such that long and boring real-time surveillance work from the content provider can be outsourced by the media content medium to a surveillant who is looking to profit from such work.
2. The invention implements an auditing mechanism that provides incentives for a user to select and complete playback of the media content on the user computer 12 by granting a reward after receiving a notification of task accomplishment, thereby achieving the goal of media content advertising and distribution.
3. The invention provides incentives to attract qualified surveillants, who are likely to maintain focus on real-time surveillance videos, such that events and incidents can be reported to the police, hospital, etc. Therefore, the quality of surveillance can be significantly improved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A computer-implemented method for auditing real-time surveillance video content, said computer-implemented method to be implemented using a host computer and comprising the steps of:
(A) configuring the host computer to transmit the real-time surveillance video content to a user computer;
(B) configuring the host computer to receive a message transmitted from the user computer as or after the user computer plays or has played the real-time surveillance video content, the message being associated with at least one of:
completion of the playing of the real-time surveillance video content,
finding a difference in the real-time surveillance video content, and
monitoring for occurrence of an abnormal event in the real-time surveillance video content; and
(C) configuring the host computer to grant a reward to an account associated with the user computer based on the message received from the user computer in step (B).

2. The computer-implemented method as claimed in claim 1, wherein step (B) includes:
configuring the host computer to receive a notification transmitted from the user computer;
configuring the host computer to transmit a questionnaire associated with the real-time surveillance video content in response to receipt of the notification from the user computer; and
configuring the host computer to receive the message, which is a response from the user computer to the questionnaire transmitted by the host computer.

3. The computer-implemented method as claimed in claim 1, further comprising, prior to step (A), a step of configuring the host computer to conduct a certification process with the user computer for establishing the account associated with the user computer.

4. The computer-implemented method as claimed in claim 3, wherein a set of the account and a password dedicated to the user computer is established in the certification process.

5. The computer-implemented method as claimed in claim 3, wherein:
in the certification process, the host computer assigns an aggregate value to the account associated with the user computer;
the computer-implemented method further comprising, after step (B), the step of configuring the host computer to update the aggregate value based upon the message received from the user computer.

6. The computer-implemented method as claimed in claim 7, further comprising, prior to step (A), the step of:
configuring the host computer to receive a request for the real-time surveillance video content from the user computer, and to inspect the aggregate value assigned to the account associated with the user computer;
wherein step (A)is performed only when the aggregate value is not smaller than a predetermined threshold value assigned by the host computer to the real-time surveillance video.

7. The computer-implemented method as claimed in claim 1, wherein the reward is one of a monetary reward and a point reward.

8. The computer-implemented method as claimed in claim 1, further comprising the step of:
configuring the host computer to receive the real-time surveillance video content from a client computer associated with a content provider.
